(19) United States
(12) Patent Application Publication
(10) Pub. No.: US 2005/0131677 A1
(43) Pub. Date: Jun. 16, 2005

(54) Dialog driven personal information manager

(76) Inventor: Ramin Oliver Assadollahi, Konstanz (DE)

Correspondence Address: JONATHAN D. FEUCHTWANG, 150 NORTH WACKER DRIVE, SUITE 1200, CHICAGO, IL, 60606, US

(21) Appl. No.: 10/734,390

(22) Filed: Dec. 12, 2003

(51) Int. Cl. G10L 21/00

(52) U.S. Cl. 704/201

(57) ABSTRACT

A personal information manager including a data input device receiving an audio data stream, and decoding the data stream into text. A dialog manager is provided having a record mode and a dialog mode, the dialog manager examines the decoded text received to determine whether it contains one of an explicit and an implicit data processing request. The dialog manager immediately passing explicit data processing requests and queuing implicit data processing requests. An information storage/retrieval module is provided for storing and retrieving data from a database. The information storage/retrieval module executing data processing requests specified by the dialog manager. A an output module is provided for converting text received from the dialog module into speech and outputting the speech in response to a data processing request. The dialog manager passing implicit processing requests to the information storage/retrieval module during periods of inactivity.

### FIELD OF THE INVENTION

The present invention relates to a personal information manager having audio-to-text, and text-to-audio functionality, and an improved method for retrieving desired information from a database. More particularly, the personal information manager receives information in the form of spoken utterances. The audio information is decoded to text and analyzed to determine whether the text contains data or a command, and either stored or processed. Textual information retrieved by the personal information manager is converted into audio for presentation to the user.

### BACKGROUND OF THE INVENTION

Databases for storing linguistic material have become increasingly common, especially in the era of the internet. Such databases are repositories where huge amounts of data are stored centrally in a defined structure and organization. The data is typically organized in documents that contain words and maybe additional multimedia material. Searching for a document typically involves the search and match of tag words that are provided by the user and are also contained in some documents. After computing a relevancy score, the matching document(s) are sorted and output.

If we think of an internet search engine having an enormous database as an example, a broad search may retrieve an unworkably large number of documents. For the user, looking through such a list of results can be time consuming. Furthermore, the quality of the search-results depends on the search words provided.

Other databases (like address books) have a dedicated structure where data is stored in predefined places. This allows a precise retrieval of the information as long as the precise structure of the database is known. However, training the user to work with large database structures is cost intensive and time consuming. Moreover, if the structure is unknown, it may be impossible to retrieve data.

Accordingly, it is an object of the present invention to provide an improved method for accessing a selected document from a database of documents by defining an optimized trade-off between unstructured databases (e.g. internet search engines) and structured databases (e.g. address books).

Another aspect of the present invention relates to personal information managers and digital assistants (PDA's) such as those offered by the PALM Corp. and the HandSpring Corp. PDA's using the PALM Operating System® have become increasingly popular. User's access information stored in the PDA by writing on a touch sensitive screen using a so-called “graffiti” style of writing. Some users find it difficult to master the graffiti style of writing, while others find it difficult to read the display.

Accordingly it is a further object of the present invention to disclose a method for storing and retrieving information from a personal information manager using an interactive, dialog-driven natural-language approach.

### SUMMARY OF THE INVENTION

Disclosed is a personal information manager including a data input device receiving an audio data stream, and decoding the data stream into text. The personal information manager is provided with a dialog manager having a record mode and a dialog mode, the dialog manager examining the decoded text received to determine whether it contains an explicit or an implicit data processing request, immediately passing explicit data processing requests and queuing implicit data processing requests. An information storage/retrieval module is provided for storing and retrieving data from a database, and executing data processing requests specified by the dialog manager. An output module is provided for converting text received from the dialog module into speech and outputting the speech in response to a data processing request, wherein the dialog manager passes implicit processing requests to the information storage/retrieval module during periods of inactivity.

According to one aspect of the invention, the dialog manager identifies an explicit data processing request during the record mode by comparing the decoded text against a list of reserved words.

According to a further aspect of the invention, the dialog manager identifies an explicit data processing request during the dialog mode by comparing the decoded text against a list of predefined data processing requests, assigning a match score to each of the predefined data processing requests and selecting the predefined data processing request having a highest matching score as the explicit data processing request.

According to a further aspect of the invention, if the highest matching score is less than a threshold score the dialog manager passes an instruction to the output module to prompt the user to select a given data processing request from among a selected number of the predefined data processing requests.

According to a further aspect of the invention, the information storage/retrieval module passes to the dialog manager a specified number of data records retrieved in response to the data processing request if a number of retrieved data records is below a threshold number and otherwise passes characteristic words selected from the retrieved data records, and the dialog manager instructs the output module to prompt the user to select a given the characteristic word used refine the data processing request.

According to a further aspect of the invention, the personal information manager includes a global word table containing a list of all of the words stored in the database. The dialog manager examining decoded text received from the data input device to determine whether it matches to a given the word in the global word table, wherein a request for clarification is queued if the decoded text does not match any word in the global word table.

According to a further aspect of the invention, the personal information manager includes a local word table. The information storage/retrieval module stores atoms of data, each the atom having a unique identifier, and the local word table containing a list of words contained in each atom of data and the number of times each word appears in a given atom. If a number of atoms matching a data retrieval request exceeds a predetermined number, the dialog manager prompts a user to select a given characteristic word from a list of characteristic words, the characteristic words being derived from the local word tables of atoms matching the data retrieval request, the selected characteristic word being appended to a search string of the data retrieval request, thereby reducing the number of atoms matching a data retrieval request.

According to a further aspect of the invention, the characteristic words are derived by selecting a predetermined number of the most frequently occurring words from the local word tables of the atoms matching a data retrieval request, provided that that the selected word does not already appear in the search string of the data retrieval request.

Also disclosed is a method for refining a search string used to retrieve data from a database containing plural records of data. The method includes a step of maintaining a local table for each data record, the table including a list of words appearing in the data record and frequency value for each the word, where the frequency counts a number of times the word appears in the data record. The method further includes a step of selecting a predetermined number of the words whose frequency is above a threshold value from each of a plurality of the local tables, and prompting a user to select a given the word from the predetermined number of words. The selected word is added to the search string, thereby refining the search.

### BRIEF DESCRIPTION OF THE DRAWINGS

Preferred embodiments of the present invention are described herein with reference to the drawings wherein:

FIG. 1 is a block diagram showing the software architecture of the Personal Information Manager according to the present invention;

FIG. 2 is a block diagram showing the hardware architecture of the Personal Information Manager according to the present invention;

FIG. 3 is a flow diagram of the processes executed by the Personal Information Manager during Record Mode;

FIG. 4 is a block diagram of the data stored in a database according to the present invention;

FIG. 5 is a flow diagram of the processes executed by the Personal Information Manager during Dialog Mode; and

FIG. 6 is a flow diagram of the processes for maintaining the local and global word tables according to the present invention.

### DETAILED DESCRIPTION OF THE PREFERRED EMBODIMENTS

The present invention discloses a personal information manager (PIM) 100 in which information is accessed using an interactive, dialog-driven natural-language approach.

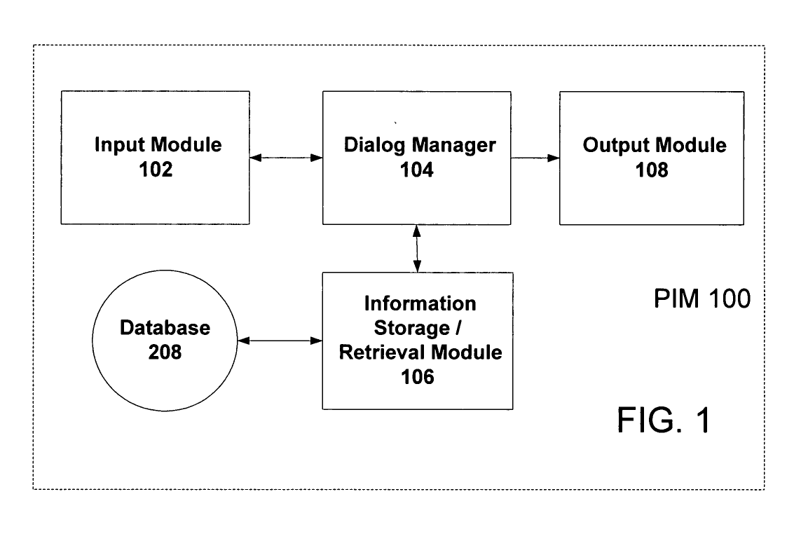

FIG. 1 is a block diagram showing the architecture of the PIM 100 according to the present invention.

In its most elementary form, the PIM 100 decodes an audio stream into text, determines whether the text contains data or a query, and either stores the data or queries and retrieves data to/from a database of stored text information.

An important aspect of the invention is that the primary mode of interaction with the PIM 100 is through spoken dialog (verbal). The PIM 100 decodes an audio stream into text, and determines whether the text contains data to be stored or a command to process stored data. Correspondingly, the unit encodes text into audio (text-to-speech) and outputs synthesized speech.

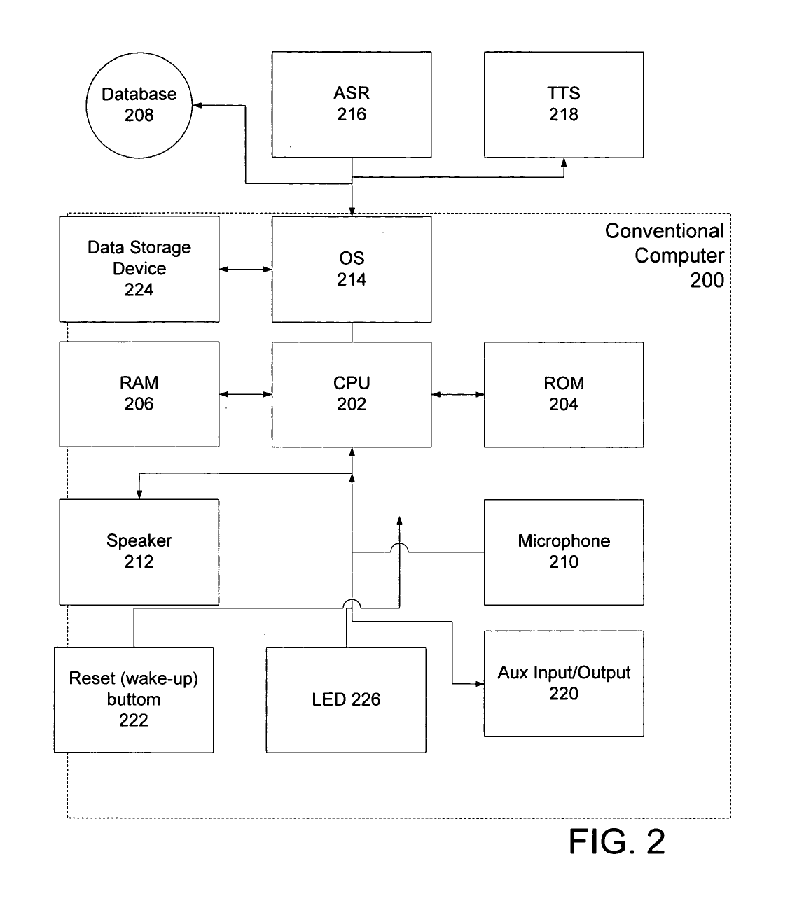

Unlike conventional data organizers the PIM 100 does not use (and is not equipped with) either a display or a keyboard in normal operation. All input and output from the PIM 100 takes the form of audio signals. One of ordinary skill in the art will appreciate that the PIM 100 may be equipped with a port or interface 220 (FIG. 2) for connection to a display and/or keyboard (e.g. during the initial configuration of the PIM 100). Likewise the port 220 may be used to backup (transfer) data from the PIM 100 to an external data storage device and back. However, in normal operation the PIM 100 is not provided with either a screen or a keyboard.

Users communicate verbally (“hands-free”) with the PIM 100. Consequently, use of the PIM 100 is more natural than conventional data organizers requiring the use of “graffiti”-style written communications. The “hands-free” operation of the PIM 100 means that it can be used by people who are unable to use conventional data organizers, e.g., visually impaired people and people unable to use the conventional “graffiti” interface.

Another important aspect of the invention relates to memory conservation. Even compressed audio data requires significantly more storage space than comparable text information. To conserve memory the PIM 100 stores data as text. No audio data is stored. Text may be stored in a variety of formats, such as American Standard Code for Information Interchange (ASCII) or rich text format (RTF). The specific format in which the data is stored is not a critical aspect of the invention, and other formats may readily be adopted.

The PIM 100 executes on a conventional computer 200 (FIG. 2) such as a personal computer. Preferably, the PIM 100 is provided on a relatively small portable or handheld computer.

FIG. 2 depicts the architecture of a typical computer 200 used to execute the PIM 100. The computer 200 includes a central processing unit 202, a read-only memory (ROM) 204, a random access memory (RAM) 206, a data storage device 224, an audio input device (microphone and sound chip) 210, and an audio output device (sound chip and speaker) 212. Operating system software (OS) 214 controls the operation of the computer.

In FIG. 2, the OS 214 is shown loaded in RAM 206 (from the data storage device 224); however the OS 214 may alternatively be provided in ROM, Flash-RAM or equivalent non-mechanic memory forms 204.

According to a preferred embodiment, the operating system 214 is Microsoft Windows CE®. However, the choice of operating system 214 is not a critical aspect of the invention, and other operating systems may readily be adopted.

As will be explained below, according to a preferred embodiment, the input device 210 includes a directional microphone or other like device, and the audio output device 212 includes a speaker or other like device.

The computer 200 may be connected to another computer 200-a (not illustrated) to backup or transfer the data stored in the PIM 100. One of ordinary skill in the art will appreciate that the transfer of data between computer 200 and computer 200-a (not illustrated) may be accomplished with or without a direct physical connection. In operation the computer 200 operates as a stand-alone system without a display or a keyboard.

The PIM 100 may reside in whole or in part as software stored in the data storage device 224 or other such storage device, or as hardware such as the ROM 206 or the like.

For ease of comprehension, the PIM 100 will be described in terms of a number of functionally distinct modules. However, the functionality of two or more modules may be combined into a single module or modules may be split up without departing from the scope and spirit of the invention.

As described herein, the PIM 100 (FIG. 1) consists of an Input Module 102, a Dialog-Manager 104, an Information Storage/Retrieval Module 106 and an Output Module 108.

One of the attractive features of the PIM 100 is its ability to receive and interpret the user's spoken words (utterances).

Audio signals received from the microphone 210 are decoded into text by automated speech recognition software (ASR) 216 such as “Via voice” manufactured by IBM Corp. or “Naturally Speaking” by Scansoft, Inc. The PIM 100 is capable of interpreting text in any number of formats. However, according to a preferred embodiment the ASR 216 provides text using the American Standard Code for Information Interchange (ASCII).

The ASR 216 receives a stream of audio information, decodes it into text and passes it to the Input Module 102. The Input Module 102 may analyze the structure of the decoded text (shallow parse) to determine whether the decoded text contains a request to toggle between operating modes or a request to store or retrieve data from a database 208 residing on the data storage device 224.

If the Dialog Manager 104 determines that the text contains data to be stored, it passes it on to the Information Storage/Retrieval Module 106 together with a command to tag the data and store it in the database 208. It should be appreciated that the present invention is not limited to the specific architecture disclosed herein. For example, there might be a direct connection between the Input Module 102 and the Information Storage/Retrieval Module 106.

One of the general tasks for the Input Module 102 and the Dialog Manager 104 is to decide whether the access to the database 208 should be done on structured or unstructured data:

1. Depending on the operating mode of the PIM 100, the Input Module 102 will assume that the decoded text contains a command and will attempt to determine whether the text conforms to one of the pre-defined message requests. Each pre-defined processing request is associated with a unique identifier (MSG_IN_ID). If the Input Module 102 is able to match the processing request with one of the pre-defined message requests, the Input Module 102 passes the identifier (the MSG_IN_ID) to the Dialog Manager 104 which interacts (via Information Storage/Retrieval Module 106) with the structured part of the database 208 to calculate an answer to the command.

2. If the Input Module 102 not able to match the processing request to one of the pre-defined requests, the whole utterance is passed (via the Dialog Manager 104 using a special MSG_IN_ID) as an information retrieval request to the Information Storage/Retrieval Module 106. Module 106 will then retrieve information from the unstructured part of the database 208. The result of the retrieval process is again encoded as a MSG_OUT_ID together with additional information (the result of the retrieval process).

In both cases, the Input Module 102 passes an identifier of the processing request (MSG_IN_ID) to the Dialog Manager 104 which interacts with the database 208 via the Information Storage/Retrieval Module 106 to calculate an answer to the processing request.

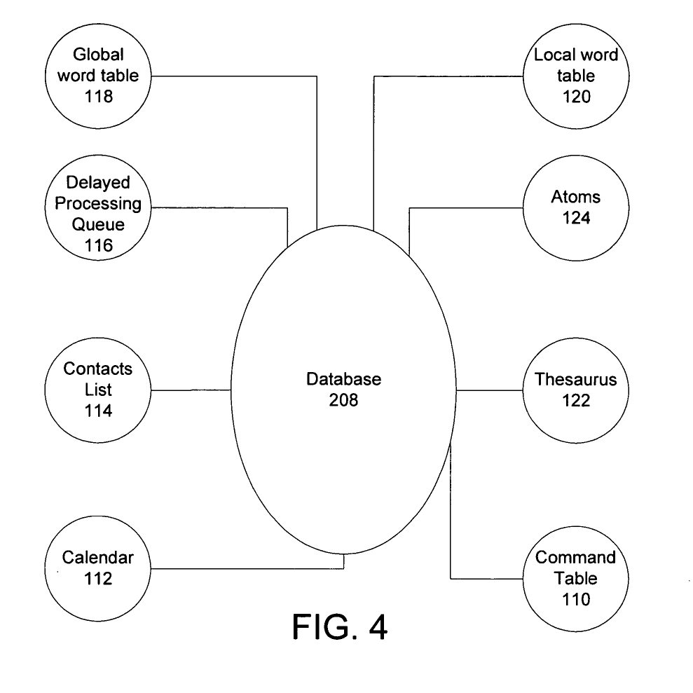

This architecture allows the PIM 100 to hide the complexity of various data structures (as given in FIG. 4) from the user and to unite all interactions in a dialog-driven interface. According to a preferred embodiment interaction with the PIM 100 is conducted orally using natural language sentences. As will be explained in further detail below, interactions with the PIM 100 mimic natural human interaction.

The calculated answer is encoded as an identifier (MSG_OUT_ID) with additional information (e.g. the retrieved data) and is passed to the Output Module 108. The Output Module 108 converts textual data received from the Dialog Manager 104 into audio (via TTS 218) and outputs the audio to the user over the audio output device 212. Data output is provided using a text-to-speech (TTS) system 218 such as Bright Speech manufactured by Babel Technologies S.A. The TTS system 218 enables the PIM 100 to “verbally” respond to the user's queries.

In the embodiment depicted in FIG. 1, the Dialog-Manager 104 manages the interactions between the other modules; however, one of ordinary skill in the art will appreciate that other architectures may be readily substituted without sacrificing functionality. Therefore, the invention is not restricted to the precise implementation depicted in FIG. 1.

The PIM 100 has a Recording Mode and a Dialog Mode, and may optionally include a Sleep Mode:

In the Recording Mode the PIM 100 decodes an audio stream into text which is stored in the semi-structured part 124 of the database 208. As will be explained below, the PIM 100 performs an online analysis of the text to verify whether it contains an implicit or explicit command (ActiveListening™), e.g. a command to toggle into Dialog Mode.

In the Dialog Mode the PIM 100 decodes an audio stream into text, interprets the text into a command, queries or modifies structured parts of the database 208, and encodes and outputs the textual results of queries as synthesized speech.

In the Sleep Mode the PIM 100 will not react nor store any data from the user. It will only react to one special command, “wake-up”. This mode is for ensuring that data which the user does not want stored, is actually not stored. To indicate the Sleep Mode visually, the PIM 100 may be equipped with an optional light emitting diode (LED) 226 which changes the color.

Toggling between operating modes may be triggered by a verbal command issued by the user, or may occur due to the expiration of an event timer (managed by the Dialog Manager 104). For example, the PIM 100 may “time-out” when an event timer expires, forcing the PIM 100 from a Record or Dialog Mode into a Sleep Mode.

An optional “wake-up” or reset button 222 may be provided to manually toggle the PIM 100 from Sleep Mode into Dialog Mode. However, the operating mode of the PIM 100 may be toggled simply by issuing a verbal command such as “go to sleep” for changing to Sleep Mode. In this context it is important to note, that a command may be a single word. For example, one could imagine changing (toggling) from Record Mode to Dialog Mode by verbally issuing a command such as “Archie”. This is a name, which should be unique in the database and the PIM 100 will react to this given name, hence further mimicking human dialogs.

Next, the two basic modes of operation will be discussed in functional detail, and the precise implementation through the four modules (102, 104, 106 and 108) will follow.

Recording Mode

There are two important aspects of the Recording Mode. First, this mode is responsible for gathering information for the semi-structured atoms 124 of the database 208. Second, it is responsible for detecting implicit processing requests (i.e. the ActiveListening™ process). Moreover, there are a limited number of explicit processing requests which may be issued in the Recording Mode. One such command is the command to switch to Dialog Mode. Another optional explicit request may be to enter the Sleep Mode.

Optionally, the PIM 100 may be provided with two different recording modes, a Continuous Recording Mode and an Explicit Recording Mode. The Continuous Recording Mode decodes and records all utterances unless otherwise instructed by the user. The Explicit Recording Mode records information in response to an explicit command and then changes to Sleep Mode. For the sake of explanation, the term Recording Mode should be understood to refer to Continuous Recording Mode unless otherwise noted.

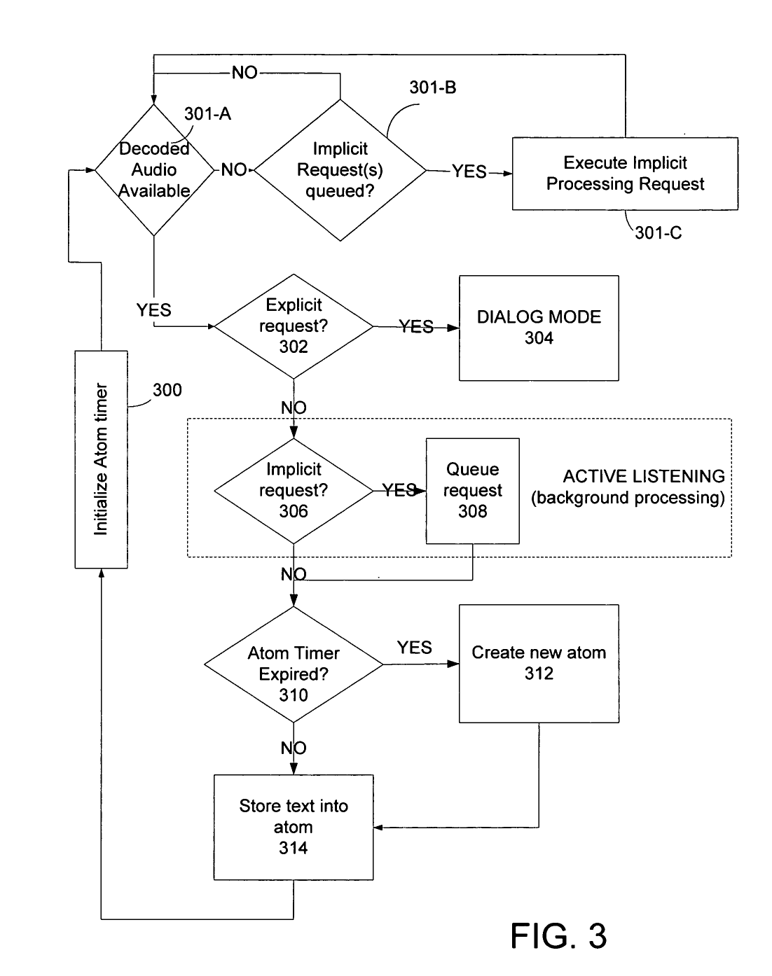

FIG. 3 is a flowchart of the processes executed by the PIM 100 during Record Mode.

In the Record Mode, the speech-recognition software 216 decodes spoken utterances word-by-word into text. Each time the PIM 100 is placed into Record Mode, the Input Module 102 resets the atom timer (step 300), and then waits for a signal from the speech-recognition software 216 that textual information is available for processing (step 301-A).

If no textual information is available, the Input Module 102 checks whether any implicit commands are present in the implicit processing queue 116 (step 301-B) and if so processes the first implicit command in the queue (step 301-C). If no implicit commands are present in the queue 116 (step 301-B) then processing return to check for textual information (step 301-A).

If textual information is present, the Input Module 102 verifies whether the decoded text contains an explicit processing request by comparing the text against a pre-defined list of chains of reserved words (commands) stored in a command table 110 (step 302). An explicit processing request is a request for immediate action (explicit command or request). For example, the user may instruct the PIM 100 to stop recording and enter the Dialog Mode or Sleep Mode (step 304).

Next, the Input Module 102 verifies whether the text contains an implicit processing request (step 306). Implicit processing requests may take several forms, and are performed in the background during periods of inactivity. By manner of example, the Input Module 102 may determine that the text contains a date or an address and store a request to prompt the user whether the date or address should be added to an optional calendar 112 (FIG. 4) or an optional contacts list 114 (FIG. 4). If an implicit processing request is detected, the request is added to the implicit processing queue 116 (FIG. 4) for subsequent background processing (step 308).

If the decoded text does not contain an explicit processing request, the Input Module 102 passes the decoded text to the Information Storage/Retrieval Module 106 for storing it in the atoms part 124 of the database 208 (step 314).

Processing now loops back to waiting to receive the next utterance (steps 301-A through 301-C).

For capturing single utterances into atoms, steps 310-314 implement a timer logic that waits after each word for a certain amount of time (e.g. 1500 ms). If there was no word following within this time frame, it is assumed that the utterance is finished and it can be stored in an atom. The detailed logic is described in the following:

Each time the PIM 100 toggles into the Recording Mode the Input Module 102 initializes an atom timer (step 300) and waits to decode the next utterance (step 301-A).

If the word does not match any commands (steps 302 and 306), then the Input Module 102 verifies whether the atom timer has expired (step 310). If the atom timer has expired then a new atom is created (step 312), the word is recorded in the (new) atom (step 314), and the atom timer is reset (step 300). Otherwise (atom timer has not expired), the word is stored into the (existing) atom (step 314), and the atom timer is reset (step 300).

Processing loops back to wait for receipt of the next decoded word (step 301-A).

According to one aspect of the invention, the PIM 100 may include an Active Listening™ Mode. Active Listening™ refers to background processing which executes during periods of inactivity in the Recording Mode.

During the construction of an atom, the Active Listening™ process examines each incoming word to determine whether there is an implicit processing request such as adding an appointment, or adding or updating an entry in the address book 114. The Active Listening™ process may also detect a possible misspelling, and prompt the user to confirm the spelling. For detection of new names, it may be checked whether the word does not match any word in a global word table 118 (FIG. 4). This may signal that the text is a proper name. Resulting actions may be the generation of a new entry in the address book 114.

The implicit or delayed processing queue 116 (FIG. 4) is a temporary storage area used as a repository for requests. Depending on user-defined parameters, the PIM 100 may automatically change to Dialog Mode and prompt the user to resolve implicit processing requests during a period of inactivity or at some other pre-defined time.

How the PIM 100 determines the presence of a date or an address is described in the section concerning the Input Module 102 further below.

Dialog Mode

In Dialog Mode the Dialog Manager 104 actively interprets the decoded text to determine the user's intention. In this mode, the PIM 100 may be interrogated for information retrieval or may provide a direct, interactive data feed to store addresses, appointments or the like.

The PIM 100 attempts to determine the user's intention from among a pre-defined list of intentions (detected by the Input Module 102). Moreover, each pre-defined intention is associated with at least one output definition (processed by the Output Module 108). The coordination of intentions and outputs is the task of the Dialog Manager 104. As will be explained below, multiple output definitions may be provided for a given intention to provide variety and make the system seem more human in its response.

Optionally, the PIM 100 may be extended to provide the user with the ability to specify alternate queries to define an intention and to define alternate (spoken) expressions to output the results of a given query.

The richness of spoken language results in many ways of specifying a query. For example, an intention may indicate a request for output such as “Where does Mr. Brown live?”, or “What is Mr. Brown's address”.

According to a preferred embodiment, intentions and outputs are defined using the extensible mark-up language (XML), however, the invention is not limited to the use of XML and other descriptive languages may be utilized.

For example, one intention matching the query above may be encoded in the following way:
<MSG-IN-ID in=“10”><ALT> what <NAME/> address </ALT></MSG-IN-ID>
   While the exact description and processing of intentions will be explained in the section “Input Module 102”, here it is important to note, that each intention is assigned unique a message ID (MSG-IN-ID, 10). For determining the user's intention, it is important to match the words “what” and “address” with a name in between. In the example, this is signified by the XML-tag “<name/>”. This acts as a variable, which should be filled with a name, e.g. “Brown”.

The MSG-IN-ID specifies which variables (arguments) the Dialog Module 104 will attempt to retrieve. As will be explained below, the corresponding MSG-OUT-ID also specifies the manner in which the PIM 100 will present the results to the user.

Names for matching may be retrieved from the Contacts List 114 in the database 208 (FIG. 4).

For other variables as part of intentions like weekdays, the Input Module 104 uses semantic classes with reference to the thesaurus 122.

A black board or Tag Table (not illustrated) is used to facilitate exchanging the current content of variables of intentions. In accordance with the previous example, “<NAME>” is set to “Brown”). For transportation of the content of variables there will be a temporary entry in the Tag Table given in table 1:

TABLE 1
The Tag Table.

| Tag name | Tag value |
|---|---|
| <DATE/> | 12.10.1973 |
| <TIME/> | 13:06:12 |
| <NAME/> | 34 |
| <NAME/> | 23, 32, 45 |
| . | . |
| . | . |
| . | . |

<NAME/>-tags have PID's (person IDs) as values, these refer to a unique entry of an individual in the Contacts List 114. Moreover, <NAME> tags can contain multiple PID's. This will be the case when the user issues an ambiguous name (e.g. there might be more than one individual in the Contacts List 114 with the last name “Brown”).

Usually, the Input Module 102 extracts names, times and dates from the incoming stream of words and stores them in the Tag Table. The Dialog Manager 104 may modify entries of the Tag Table, for example, when the user gave a clarifying first name for a name that was ambiguous in his preceding request. The Output Module 108 finally, uses the Tag Table to fill in variables in the pre-defined answers.

Once the Dialog Manager 104 has assigned the appropriate value to each of the variables, it passes the MSGIN-ID of the intention together with the Tag Table to the Information Storage/Retrieval Module 106. The Information Storage/Retrieval Module 106 accesses the database 208 to perform the action specified by the intention. The action could be a data retrieval operation such as searching for an address or appointment, or it could be a data storage operation directing the insertion or modification of an appointment or address.

If the intention specifies data retrieval, and the Information Storage/Retrieval Module 106 was able to retrieve the desired information then it adds the results to the Tag Table.

Dialog Manager 104

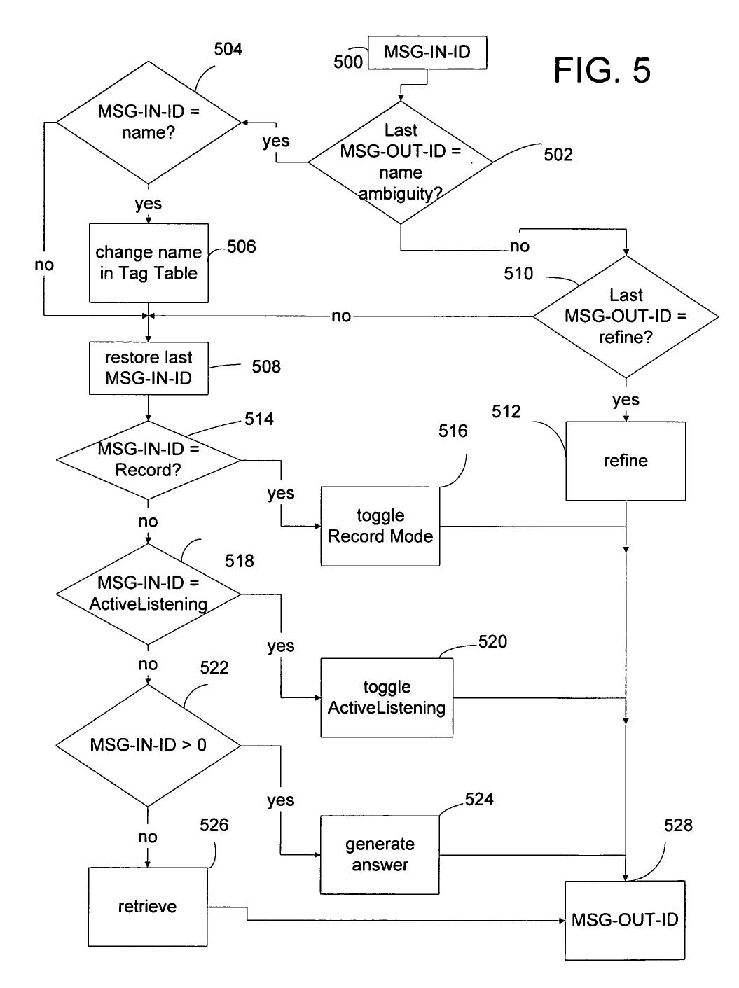

The following detailed description of the Dialog Manager 104 refers to FIG. 5. As described above, the Dialog-Manager 104 manages the relationship between MSG-IN-IDs and MSG-OUT-IDs.

In the most simple case, MSG-IN-ID=MSG-OUT-ID when all other data is given (i.e. the Tag Table is filled with all necessary data). The other data may comprise names, dates etc, which is additional information that describes specificities of the actions to do. So, in “What is Mr. Brown's address” the intention is to get the address of someone. The specificity in this case is that the name of the one whose address is sought is “Brown”. In this case, the incoming MSG-IN-ID (FIG. 5, step 500) delivered by the Input Module 102, will lead to a positive answer to the if-clause (step 522). This leads to the retrieval of the address of Mr. Brown in the Contacts List 114 (step 524) and the generation of the MSG-OUT-ID (step 528).

In other cases, such as ambiguities in names, the Dialog-Manager 104 generates a sub-dialog (“Do you mean Bob or Jim Brown?”) in order to proceed with the super-ordinate request, which is temporarily stored. This ambiguity is detected by multiple PersonIDs (PIMs) in a <NAME\>-tag in the Tag Table and will lead to a different MSG-OUT-ID for asking back. This MSG-OUT-ID will be stored together with the original MSG-IN-ID and the Tag Table. After the user's next utterance, the stored MSG-OUT-ID will lead to a positive answer to the if-clause (step 502). If the user delivered some additional information (step 504) about the name (e.g. the first name), then the Tag Table will be restored, the name will be modified (step 506) and the original MSG-IN-ID will be restored (step 508). With the old MSG-IN-ID (denoting the user's intention to get the address of Mr. Brown) and the unambiguous Tag Table, the algorithm can proceed as described above (steps 524 and 528).

An additional task for the dialog manager 104 is to determine how the information is retrieved from the database. Generally, there are two ways to access information: accessing defined structures in dedicated databases such as the Contact List 114 or the Calendar 112 and the other way is information retrieval on the semi-structured collection of Atoms 124.

Also, the communication between the Information Storage/Retrieval Module 106 and the Dialog Manager 104 is handled by MSG-IN-IDs. If the Input-Module is not able to match the user's request to an adequate intention (with a corresponding MSG-IN-ID), it will deliver a specific ID (e.g. “−1”). This will lead to a negative answer to the if-clause 522. So, when receiving this specific ID, the Dialog Manager 104 will set the whole utterance on the Tag Table and call the Information Storage/Retrieval Module 106 with a request to search the database (step 526). The retrieved information as well as information about the structure of the retrieved information is then returned to the Dialog Manager 104. The Dialog Manager 104 analyses the structure of the retrieved information and generates an adequate MSG-OUT-ID (step 528). The specific algorithm of how the retrieved information is generated is explained in the section “Information Storage/Retrieval Module 106”.

As described above, there may be explicit commands like to toggle to the Record Mode, this is exemplified in the processing step 514 with a special MSG-IN-ID followed by the internal change of the mode (step 516). User-options may be handled in the same way (for example toggle the ActiveListening™ feature (steps 518 and 520).

One important aspect of the present invention is that it fuses dialog systems and information retrieval systems. From the user point of view, the transition between the two systems is seamless.

Input Module 102

The Input Module 102 is responsible for the detection of intentions in a stream of words. As described above, in the preferred embodiment, intentions are defined in XML. The invention is not limited to the use of XML, and one of ordinary skill in the art will readily appreciate that other descriptive languages may readily be substituted.

The definition of an intention begins with a message ID identifier, e.g., <MSG-IN-ID in=“10”>, and ends with a message terminator, e.g., “</MSG-IN-ID>”.

Intentions can be expressed in several ways. These alternatives can be captured in alternate definitions. Alternate expressions of a single intention may be grouped together under a single MSG-IN-ID. In the XML segments provided throughout the present disclosure, alternate expressions are signified using the <ALT>-tag, where <ALT> signals the beginning of an expression and </ALT> signals the end of an expression.

Words within one ALT-tag are matched in order to classify the stream as an intention. If a threshold number of words contained in one ALT-tag of an intention are matched, then the intention is treated as recognized. In concurring intentions, the intention with the highest (relative to its number of words) match score is chosen.

Within each expression, text within the angled brackets and a slash “<\>” designates a variable, e.g., <NAME\>, whereas lowercase text designates a keyword, e.g., “what”.

The following XML code segment (MSGIN-ID 10) contains two alternate expressions for requesting the address of a person:

```
<MSG-IN-ID in = “10”>
    <ALT> what <NAME\> address </ALT>
    <ALT> where <NAME\> live </ALT>
</MSG-IN-ID>
```

The first expression contains the keywords “what” and “address” and the variable “NAME”, and the second (alternate) expression contains the commands “where” and “live” and the variable “NAME”. The PIM 100 will respond to either expression “What is Mr. Smith's Address” and “Where does Mr. Smith live” by providing the requested address.

To simplify the definition of intentions, the XML language may be extended to include a Boolean XOR operator. Thus the expression (a|b) specifies that either “a” or “b” must be matched.

The following XML code snippet specifies that MSG-IN-ID 60 contains two alternate expressions, and each expression contains alternate commands and/or arguments. The first expression is satisfied when the decoded text specifies one or more words belonging to the specified semantic class of Weekday, Day or Date, word or words belonging to the semantic class of Time, a keyword such as “meet” or “visit” and members of the semantic class NAME.

```
<MSG-IN-ID in = “60“>
    <ALT>
        (<WEEKDAY/>|<DAY/>|<DATE/>) at <TIME/> i (meet | visit)
        <NAME/>
    </ ALT>
    <ALT>
        (<WEEKDAY/>|<DAY/>|<DATE/>) at <TIME/>
        (meeting | appointment | dinner) <NAME/>
    </ ALT >
</MSG-IN-ID>
```

The recognition of an intention (parsing) in the Input Module 102 consists of identifying important words in the textual stream.

The Thesaurus 122 (FIG. 4) is used to translate words like “Monday” or “Sunday” belong to the semantic class “DAY” (and to the semantic class “date”), and that “January” through “December” belong to the semantic class “month” (and to the semantic class “date”). PIM 100 determines the presence of a date or an address using the Thesaurus 122 and a series of semantic tags. The Thesaurus 122 is used to identify that Monday through Sunday belong to the semantic class “day” (and to the semantic class “date”), and that January through December belong to the semantic class “month” (and to the semantic class “date”). Expressions for times may be delivered by the ASR 216 in the format “hh:mrn o'clock”. The parser of the Input Module 102 is able to extract such multi-word expressions the parser can analyze not only the current word but its left context, the recognized words before the current word. Pattern matching then extracts invariable parts like “:” or “o'clock”. The matching process for dates “12.10.1973” or “1973/10/12” is done in an analogous way. Internally, all weekdays, dates, etc are computed to real dates, e.g. “this Monday” is translated to the real date it refers to.

Through the definition of intentions, the system will know that the response to this query should contain a day or date and possibly a time, if the user makes a query about when a meeting is scheduled.

The parsing of a sentence in the Input Module 102 relies on matching incoming items to sequences of items given in the definition of intentions (in the Command Table 110). As pointed out earlier, intentions can have several alternatives and these are processed independently. The items specified in each alternative intention can be words, semantic tags, name tags or disjunctions of these (e.g. “(meeting|date)” in table 2.1, MSG-IN-ID 1, alternative 1, second item).

The Command Table 110 may look like the one given in table 2.1. For each intention (identified by a unique MSG-IN-ID given in column 1) and each of its alternatives (designated by numbers in column 2) all items are stored in an array. At the beginning of parsing an utterance, for each row a pointer is set to the first item indicating that for this alternative, this is the current item that has to be match in the current stream of decoded words.

During the shallow parse, real names, dates and times are translated to their corresponding tags and are put on the Tag Table described above. Then a matching is performed for each row. The incoming item will be matched against the item the pointer points to. If there is a match, the pointer for this row is moved to the next item. An example is given in table 2.2 for the incoming item “tomorrow” which is translated to the <DATE>-tag first and then matched. In row two (i.e. MSG-IN-ID 1, alternative 2), a match occurred and the pointer is moved to the next item while the pointers in all other rows remain at their items. In table 2.3 the next word “I” matched two rows, the first as well as the second. The respective pointers are moved to the following items. For disjunctive items, it is sufficient to match one of the words in the disjunctive expression.

During parsing, a match score is computed for each row. The match score in the present invention is simply the number of items matched divided by the total number of items of the row.

The row (alternative) with the highest match score is the winner and if the match score is above a defined threshold its MSG-IN-ID will be passed to the Dialog Manager 104. This is done to generate hypotheses about the user's intention. If the match score of the winning alternative is under the threshold, a certain MSG-IN-ID (e.g. “−1”) is generated to indicate that no utterance matched the incoming stream of words. As described above, the Dialog Manager 104 will then pass on the user's utterance to the Information Storage/Retrieval Module 106 for retrieving the semi-structured Atoms database 124.

It is important to note that the described algorithm for the Input Module 102 is one example for analysing the user's utterance. One of ordinary skill in the art will appreciate that other implementations may be used.

TABLE 2.1
Table at the beginning of parsing.

| MSG-IN-ID | Alt | 1^{st} item | 2^{nd} item | 3^{rd} item | 4^{th} item | . . . | No of items |
|---|---|---|---|---|---|---|---|
| 1 | 1 | i [symbol] | (meeting\|date) | <NAME/> | <DATE/> | | 4 |
| 1 | 2 | <DATE/> [symbol] | I | (see\|visit) | <NAME/> | | 4 |
| 2 | 1 | what [symbol] | time | | | | 2 |
| 3 | 1 | . . . | | | | | . . . |
| 3 | 2 | . . . | | | | | |
| . | . | | | | | | |
| . | . | | | | | | |
| . | . | | | | | | |

TABLE 2.2
First incoming word: “tomorrow”, match
with the semantic tag <date>

| MSG-IN-ID | Alt | 1^{st} item | 2^{nd} item | 3^{rd} item | 4^{th} item | . . . | No of items |
|---|---|---|---|---|---|---|---|
| 1 | 1 | i [symbol] | (meeting\|date) | <NAME/> | <DATE/> | | 4 |
| 1 | 2 | <DATE/> | I [symbol] | (see\|visit) | <NAME/> | | 4 |
| 2 | 1 | what [symbol] | time | | | | 2 |
| 3 | 1 | . . . | | | | | . . . |
| 3 | 2 | . . . | | | | | |
| . | . | | | | | | |
| . | . | | | | | | |
| . | . | | | | | | |

TABLE 2.3
Next word: “I”

| MSG-IN-ID | Alt | 1^{st} item | 2^{nd} item | 3^{rd} item | 4^{th} item | . . . | No of items |
|---|---|---|---|---|---|---|---|
| 1 | 1 | i | (meeting\|date) [symbol] | <NAME/> | <DATE/> | | 4 |
| 1 | 2 | <DATE/> | I | (see\|visit) [symbol] | <NAME/> | | 4 |
| 2 | 1 | what [symbol] | time | | | | 2 |
| 3 | 1 | . . . | | | | | . . . |
| 3 | 2 | . . . | | | | | |
| . | . | | | | | | |
| . | . | | | | | | |
| . | . | | | | | | |

Output Module 108

The Output Module 108 of the present invention is responsible for communicating the results of the user's intention. More particularly, the Output Module 108 uses the text-to-speech (TTS) system 218 to output natural language results acoustically.

According to a preferred embodiment, the output of the TTS system 218 is determined by pre-defined XML output definitions. Like the intentions used to specify a request, each output definition is assigned unique a message ID (MSG-OUT-ID).

The definition of an intention begins with a message ID identifier, e.g. <MSG-OUT-ID out=“10”>, and ends with a message terminator </MSG-OUT-ID>.

Alternate expressions of a single output may be grouped together under a single message-out ID. Alternate expressions are signified using the keyword <ALT> and its corresponding terminator </ALT>. If alternate expressions are provided for a given MSG-OUT-ID definition, then the Output Module 108 will randomly pick one of the alternate expressions. One important aspect of the present invention is that the PIM 100 has multiple possibilities to realize an answer. This greatly enhances the naturalness of the systems behavior.

In the following XML snippet, MSG-OUT-ID 10 is defined with two alternate ways of expressing the “ADDRESS” for “NAME”.

```
<MSG-OUT-ID out = “10“>
    <ALT>
        <NAME/>'s address is <ADDRESS/>.
    </ALT>
    <ALT>
        <NAME/> lives in <ADDRESS/>.
    </ALT>
</MSG-OUT-ID>
```

In the following XML snippet, MSG-Out ID 60 is defined to remind the user of an appointment with “NAME” on “DATE” at “TIME”.

```
<MSG-OUT-ID out = “60“>
    <ALT>
        Ok [<USER/>|my friend], you have an
        appointment with <NAME/> on
        <DATE/> at <TIME/>.
    </ALT>
</MSG-OUT-ID>
```

The output definitions (MSG-OUT-ID's) described here not only can express one verbal action in different ways using the ALT-tags but can also vary the contents of brackets: [a|b] means that the Output Module 108 can choose one or none from a or b, (a|b) exactly one from a or b and {a|b}, one, none or multiple of a and b. Thus, the verbal realization of MSG-OUT-ID 60 from above might be varied between “Ok, . . . ”, “Ok Ramin, . . . ” and “Ok my friend, . . . ”.

According to one aspect of the invention, the Output Module 108 attaches various weights to different the output alternatives to improve the naturalness of the spoken dialog.

According to another aspect of the invention, the weight assigned to the various output alternatives within a given output definition (MSG-OUT-ID) will dynamically vary in response to the detected usage of such terms by the user. In this manner the system attempts to mimic the user's manner of specifying verbal actions.

Information Storage/Retrieval Module 106

The Information Storage/Retrieval Module 106 is responsible for building up and interrogating the database 208. As mentioned before, the database 208 consists of structured data and semi-structured data. Which data is accessed is defined by the Dialog Manager 104 and conveyed through the MSG-IN-IDs. Generally, data that is not represented in structured databases will be asserted to the semi-structured Atom database 124. Semi-structured data is added to the atom database 124 during the Recording Mode, while it is retrieved in Dialog Mode. In Dialog Mode structured data is processed on the structured databases 114 and 112 (Contacts List and Calendar). According to a preferred embodiment, all data is stored in an XML format. However, separate special purpose databases may optionally be maintained for Contacts 114 and the like.

The textual content is stored in a semi-structured form. According to a preferred embodiment, the data is augmented by XML-tags containing the time and date of recording. These tags may be used to establish a chronological order of the pieces of knowledge. One of ordinary skill in the art will appreciate that the definition of the tags may be accomplished using descriptive languages other than XML without departing from the scope and spirit of the invention.

An example is provided in table 3. Each atom of information is provided with XML labels that include the time and date the atom was created. There may be several TIME-tags within one DATE-tag, but no two DATE-tags may have the same content of the “d” variable and no two TIME-tags within one DATE-tag may have the same content of the “t” variable. An Atom is defined by the content between beginning of a TIME-tag (<TIME t=“hh:mm:ss”>) and the end of a TIME-tag (</TIME>). Each atom can thus be uniquely identified by the time and date it is inserted. However, other unique identifiers are imaginable without changing the scope and spirit of the invention.

TABLE 3
Database entry with two atoms.

```
<DATE d = “30.08.1999”>
    <TIME t = “13:40:39”>
        The current CEO of Microsoft is Steve Ballmer.
    </TIME>
    <TIME t = “13:41:56”>
        Handheld-computer company Palm said its net loss widened in
        its fiscal first quarter, while its sales fell 20%. The
        company reported a net loss of $258.7 million, or 45 cents
        a share, according to GAAP, compared with a net loss of
        $32.4 million, or 6 cents a share, in the same period
        last year.
    </TIME>
</DATE>
```

Next, the process of adding an utterance (i.e. PIM 100 is in Record Mode) to the database 208 is described. The Dialog Manager 104 will pass a complete textual utterance is to the Information Storage/Retrieval Module 106 which is stored tagged with the XML-tags as described above and stored in the Atom database 124.

Next, the Information Storage/Retrieval Module 106 filters the raw decoded text to remove (“stop”) words which do not contribute to the meaning but only have syntactic function. Table 4 contains a list of such stop words. Generally, only meaningful content words such as verbs, nouns, adjectives and adverbs as well as names and numbers will remain after filtering. Words which successfully pass the filtering are termed residual words. The removal of stop words reduces the storage requirements for the Global and Local Word Tables (118, 120) and expedites the search process.

TABLE 4
Examples for stop words.

| | | | |
|---|---|---|---|
| The | And | Which | Without |
| Or | With | To | Is |
| Very | For | | |

The Information Storage/Retrieval Module 106 maintains a Global Word Table 118 (e.g., Table 5) containing a list all words in the Atom database 124, their reference to the atoms (identified through their XML labels) in which they occur, the number of atoms in which they occur and how often they occur over all atoms. Further, each word is given a unique number (primary index). Thus when querying the Atom database 124, the search word may be looked up in the Global Word Table 118 and references to all the atoms containing the word are immediately known. This speeds up the database retrieval.

The Information Storage/Retrieval Module 106 further maintains a Local Word Table 120 (e.g., Table 6) which stores the number of occurrences for a particular word for each single atom (identified by its XML labels) and the primary index referring to its corresponding entry in the Global Word Table 118. Thus the Global Word Table 118 incorporates a word-centric view on the data in the Atoms database 124, while the Local Word Table 120 incorporates an atom-centric view.

TABLE 5
Example for the Global Word Table 118.

| . | |
|---|---|
| . | |
| . | |
| Word Form: | “car” |
| Index Number: | 124 |
| Contained in: | <DATE d = “12.10.2002”><TIME t = “21:02:04”>, |
| | <DATE d = “16.10.2002”><TIME t = “12:20:15”>, . . . |
| Global | 2045 |
| Frequency: | |
| Word Form: | “brown” |
| Index Number: | 125 |

TABLE 6
Example for the Local Word Table 120

| . | | | |
|---|---|---|---|
| . | | | |
| . | | | |
| Atom: | <DATE d = “12.10.2002”><TIME t = “21:02:04”> | | |
| Words: | “car”, | ”brown”, | “drove”, . . . |
| Local Frequencies: | 2, | 1, | 3, . . . |
| Indices: | 124, | 125, | 12, . . . |
| Atom: | <DATE d = “16.10.2002”><TIME t = “12:20:15”> | | |
| Words: | “birthday”, | “brother”, | “cake”, . . . |
| . | . | | |
| . | . | | |
| . | . | | |

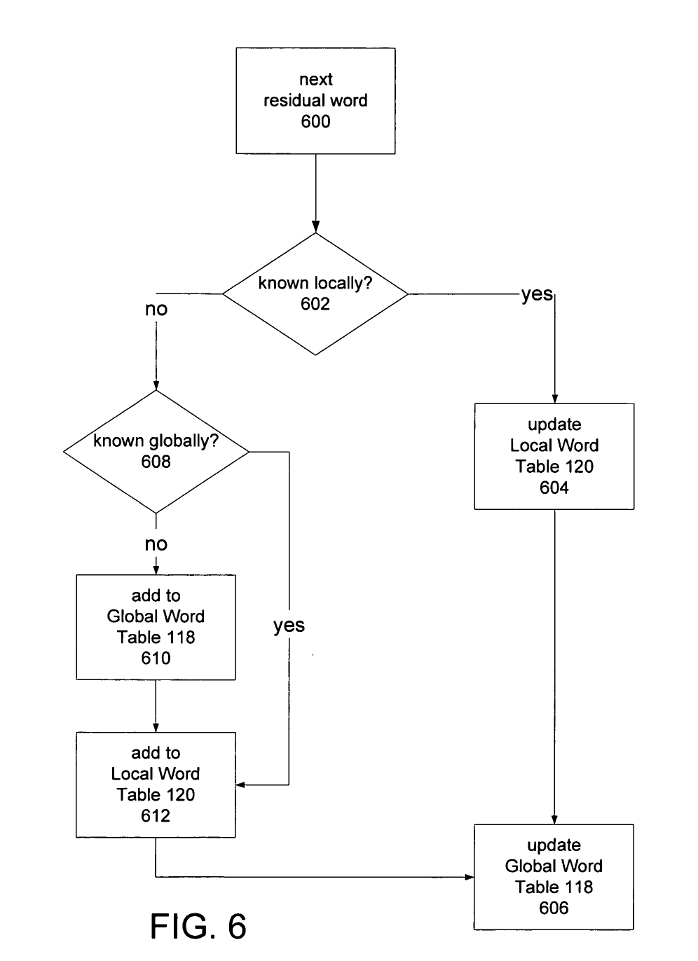

When inserting a new utterance, the Information Storage/Retrieval Module 106 next updates the Local and Global Word Tables (118, 120) for the words that remain after filtering. The Information Storage/Retrieval Module 106 examines whether a given residual word already appears in the Local Word Table 120 (FIG. 6., steps 600, 602). If the word appears in the Local Word Table 120 then it must (by definition) appear in the Global Word Table 118, and the frequency is updated in tables 118, 120 (steps 604, 606).

If it does not appear in the Local Word Table 120, then the PIM 100 examines whether the given word appears in the Global Word Table 118 (step 608). If it does not (i.e., word does not appear in current atom or any other atom) then the word is added to both the Global and Local Word Tables 118, 120 (steps 610, 612).

Otherwise, if the word appears in the Global Word Table (but not the Local Word Table 120), then the word is added to the Local Word Table 120 (step 612), and the frequency (counter) is updated in the Global Word Table 118 (step 606).

In sum, storing an utterance in the database 208 includes several steps: tagging the utterance with date and name and storing it in the Atoms database 124, filtering the utterance to remove uninformative words, updating Global and Local Word Tables (118, 120) for the residual words.

In the following, retrieval from the Atom database 124 is described.

Consider the request “What car does John drive?” In the preferred embodiment, the answer to this question was not stored in the structured databases Contacts List 114 and the Calendar 112. Moreover, the request will not match any commands in the Command Table 110. Thus, the Input Module 102 will issue the special MSG-IN-ID (e.g. “−1”) to reflect that it has not found a matching command (cf. step 522, FIG. 5) and the Dialog Manager 104 will pass on the request to the Information Storage/Retrieval Module 106 (step 526, FIG. 5).

Information Storage/Retrieval Module 106 will first filter the request (remove stop words) into “car John drive” and will search the Atom Database 124 for atoms containing these remaining three words. This is done using the Global and Local Word Tables 118, 120.

The selection of an atom that best corresponds to the request is done based upon a three step decision:

1. If only a single atom contains all three words “car” and “John” and “drive”, then the Information Storage/Retrieval Module 106 will extract the information from the atom, add it to the Tag Table (cf. table 1) and return a MSG-OUT-ID to the Dialog Manager 104 (steps 524, 528, FIG. 5).

2. If there are multiple atoms which satisfy the request, then the Information Storage/Retrieval Module 106 will rank the output results, and specify a different MSG-OUT-ID to output a predefined number of results having the highest ranking via the Tag Table.

3. If the number of atoms which satisfy the request exceeds a predetermined threshold, the PIM 100 will attempt to categorize the results into a manageable number of clusters (e.g. three or four) identified by characteristic words. These characteristic words are added to the Tag Table and a MSG-OUT-ID is returned prompting the user to choose from these words.

In the following, these three steps will be described in more detail:

In the simple case (1) the detailed procedure for finding an atom containing all words is defined as follows: the Information Storage/Retrieval Module 106 examines the Global Word Table 118 for “car” and retrieves a first list of atoms, then searches the Global Word Table 118 for “John” and retrieves a second list of atoms, and finally searches the Global Word Table 118 for “drive” and builds a third list of atoms.

If none of the words located in the Global Word Table 118, a MSG-OUT-ID is generated describing that no results were found.

Next, the Information Storage/Retrieval Module 106 examines the atom corresponding to the intersection of the three lists.

If no single atom contains all three words (the intersection of the first, second and third set is empty) then the Information Storage/Retrieval Module 106 checks whether one or more sets of adjacent atoms contain all three words.

If so, then the Information Storage/Retrieval Module 106 checks whether one or more of the sets of adjacent atoms contains all words being sought.

In a more complicated case (2), where there are only a few atoms, the user may be provided with this information (via Tag Table) and asked to choose which one to retrieve. After having listened to one atom, the user may proceed to the next.

However, when there are tens to hundreds of atoms (case 3), this may be very time consuming. Thus one important aim of the present invention is to reduce the number of resulting atoms in a dialogic, iterative process (ProgressiveSearchSpaceReduction).

The general procedure derives a set of characteristic words to help the user to refine his search. Of course, these characteristic words will not be identical with any words contained in the initial search words. The characteristic words describing the sets will be put on the Tag Table and a specific MSG-OUT-ID is generated. Of course to further reduce the number of results, the user can freely provide additional search words.

The process of the construction of subsets of atoms and the extraction of the characteristic words is explained below.

The Global Word Table 118 contains the frequency of occurrence over all Atoms, whereas the Local Word Table 120 contains the frequency of occurrence broken down for every single Atom. Thus, the summated local frequencies of a word over all atoms is the frequency in the Global Word Table 118.

The information of local frequencies of occurrence is used to compute a sub-space of frequencies. A sub-space is defined as a sub-set of all atoms. During retrieval, the initial sub-space is the whole selection of atoms. In the first results step, a new, reduced sub-space of atoms is chosen of which each atom contains at least one of the search words. By adding more search words, the current sub-space is reduced.

The detailed description of the reduction of the search space is as follows: For every word in the filtered search request a sub-space is computed. This sub-space is the set of all atoms containing this word (derived from the current sub-space). This is done by a look-up in the Global Word Table 118. If a word is unknown in the Global Word Table 118, there will be no sub-space, and hence this word will not influence the result of the search. One of ordinary skill in the art will appreciate that unknown words may be treated differently without changing the scope of the invention.

Next, the intersection of all atoms in all sub-spaces is computed. After this procedure there is only one set of atoms and each of the atoms will contain all (known) words in the search string.

Next, the set union of all words contained in at least one of these atoms is computed.

Finally, a new search space is constructed in that for each word of the set union, a new frequency and a new list of atoms containing the word is computed. This is achieved using the Local Word Table 120. Each entry for a word will only contain the atoms that were in the intersection set mentioned above. Thus the number of atoms per word is reduced. Accordingly, the frequency of the word is also reduced as only the summed frequency over the atoms is computed. This is the use of the Local Word Table 120.

At this point the search space is reduced. In the next step, from this set of words the characteristic words are extracted.

In the preferred embodiment of the invention, for each of these words a score is computed and the words are ranked the first five words will be presented to the user.

The computation of the score is as follows:
Score=(FLocl/DLocl)/((FGlob−FLocl)/(DGlob−DLocl)),
   where FLocl is the word frequency in the current sub-space, DLocl the number of atoms in the current sub-space containing the FGlob is the word frequency according to the Global Word Table 118, and DGlob is the number atoms irrespective of the sub-space (as also stored in the Global Word Table 118). This formula thus makes use of the different probabilities of occurrence within and outside the current sub-space.

However, other formulae are conceivable without changing the scope and spirit of the invention, for example the so-called inverse document frequency which is used for document ranking in standard information retrieval systems:
Score=(1+log(FGlob))*log(N/DGlob),
where N is the overall number of atoms in the Atoms database 124.

As noted above, the user is prompted to select a given characteristic word (from among a set of characteristic words) which is most closely related to the intended answer. The selected characteristic word is then added to the initial search request to refine (FIG. 5, steps 510, 512) the search space (in order to reduce the number of retrieved atoms). However, if none of the presented characteristic words is related to the intended answer, the user may prompt the PIM 100 to present an additional set of characteristic words, in which case words with a lower ranking are chosen by the system.

If the number of results for the newly refined query exceeds the threshold, then the system will again cluster the results by characteristic words, and prompt the user to elect a characteristic word which most closely relates to the desired output. In this manner, the system enables the user to rapidly drill down to the desired results. This is another important aspect of the invention: the fusion of interactive dialog systems and information retrieval which allows to interactively refine the search (ProgressiveSearchSpaceReduction™).

It is important to note, that the whole process of constructing a reduced set candidate atoms and selection of characteristic words may be implemented differently without changing the scope and the spirit of the present invention. For example, an algorithm like the widely used Latent Semantic Indexing (a kind of Singular Value Decomposition of a vector space in which each atom is represented by a point) may be used to cluster atoms. For the m biggest clusters the system may then compute characteristic words (by any algorithm) to let the user chose from.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

Various features of the invention are set forth in the appended claims.

1. A personal information manager comprising:
a data input device receiving an audio data stream, and decoding the data stream into text;
a dialog manager having a record mode and a dialog mode, said dialog manager examining said decoded text received to determine whether it contains an explicit or an implicit data processing request, said dialog manager immediately passing explicit data processing requests and queuing implicit data processing requests;
an information storage/retrieval module storing and retrieving data from a database, said information storage/retrieval module executing data processing requests specified by said dialog manager; and
an output module converting text received from said dialog module into speech and outputting said speech in response to a data processing request;
wherein said dialog manager passes implicit processing requests to said information storage/retrieval module during periods of inactivity.

2. The personal information manager according to claim 1, wherein said dialog manager identifies an explicit data processing request during said record mode by comparing said decoded text against a list of reserved words.

3. The personal information manager according to claim 1, wherein said dialog manager identifies an explicit data processing request during said dialog mode by comparing said decoded text against a list of predefined data processing requests, assigning a match score to each of said predefined data processing requests and selecting said predefined data processing request having a highest matching score as said explicit data processing request.

4. The personal information manager according to claim 3, wherein if said highest matching score is less than a threshold score said dialog manager passes an instruction to said output module to prompt the user to select a given data processing request from among a selected number of said predefined data processing requests.

5. The personal information manager according to claim 1, wherein said information storage/retrieval module passes to said dialog manager a specified number of data records retrieved in response to said data processing request if a number of retrieved data records is below a threshold number and otherwise passes characteristic words selected from said retrieved data records, and said dialog manager instructs said output module to prompt the user to select a given said characteristic word used refine the data processing request.

6. The personal information manager according to claim 1, further comprising:
a global word table containing a list of all of the words stored in the database;
said dialog manager examining decoded text received from said data input device to determine whether it matches to a given said word in said global word table;
wherein a request for clarification is queued if the decoded text does not match any word in said global word table.

7. The personal information manager according to claim 1, further comprising:
a local word table;
said information storage/retrieval module stores atoms of data, each said atom having a unique identifier; and
said local word table containing a list of words contained in each atom of data and the number of times each word appears in a given atom;
wherein if a number of atoms matching a data retrieval request exceeds a predetermined number, said dialog manager prompts a user to select a given characteristic word from a list of characteristic words, said characteristic words being derived from the local word tables of atoms matching said data retrieval request, said selected characteristic word being appended to a search string of the data retrieval request, thereby reducing the number of atoms matching a data retrieval request.

8. The personal information manager according to claim 7, wherein said characteristic words are derived by selecting a predetermined number of the most frequently occurring words from the local word tables of the atoms matching a data retrieval request, provided that that the selected word does not already appear in the search string of the data retrieval request.

9. A method for refining a search string used to retrieve data from a database containing plural records of data, comprising:
maintaining a local table for each data record, said table including a list of words appearing in said data record and frequency value for each said word, where said frequency counts a number of times said word appears in said data record;
selecting a predetermined number of said words whose frequency is above a threshold value from each of a plurality of said local tables;
prompting a user to select a given said word from said predetermined number of words; and
adding said selected to said search string.
